(19) United States
(12) Patent Application Publication
(10) Pub. No.: US 2023/0141080 A1
(43) Pub. Date: May 11, 2023

(54) WELDING ELECTRODE FOR SHEETS OF ALUMINUM OR STEEL, AND METHOD FOR PRODUCING THE ELECTRODE

(71) Applicant: LEBRONZE ALLOYS, Suippes (FR)

(72) Inventors: Francois PRIMAUX, Isles Sur Suippes (FR); Thierry SOREAU, Sarry (FR); Samuel DETREZ, Souain Perthes les Hurlus (FR); Alain BOUYER, Selestat (FR)

(21) Appl. No.: 16/962,979

(22) PCT Filed: Jan. 10, 2019
(86) PCT No.: PCT/FR19/00007

§ 371 Date: Jan. 22, 2021

(30) Foreign Application Priority Data
Jan. 18, 2018 (FR) 18 504 08

(51) Int. Cl. B23K 35/02; B23K 35/30; B23K 35/40; B23K 11/30

(52) U.S. Cl. CPC B23K 35/0261; B23K 35/302; B23K 35/40; B23K 11/30

(57) ABSTRACT

The electrode for welding sheets of steel or aluminum, with a conductivity greater than or equal to 90% IACS and made of an alloy including, by weight based on the total weight of the alloy, chromium in a proportion higher than or equal to 0.1% and lower than 0.4%, between 0.02 and 0.04% of zirconium, lower than 0.015% of phosphorus, the remainder being copper and less than 0.1% of unavoidable impurities. The electrode structure advantageously includes incoherent chromium precipitates, more than 90% of which have a projected surface area of less than 1 μm², the precipitates having a size of between 10 and 50 nm. The electrode has a fiber structure of radial fibers, each fiber having a thickness of less than 1 mm and a substantially central fibreless region that has a diameter of less than 5 mm. The invention also relates to a method for producing the electrode.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the field of welding electrodes.

The invention more particularly relates to welding electrodes by copper resistance.

The electrodes according to the invention will in particular be of special interest for welding aluminum sheets to one another.

The electrodes according to the invention can also be implemented for welding steel sheets.

### 2. Description of Related Art Including Information Disclosed Under 37 CFR 1.97 and 37 CFR 1.98

By way of preliminary remark, in the remainder of the description, “aluminum sheets” refer to sheets manufactured from alloys comprising aluminum, in particular sheets made from Al—Mg—Si (aluminum-magnesium-silicon) alloy or Al—Mg—Mn (aluminum-magnesium-manganese) alloy.

Once these aluminum sheets are welded and assembled, they are in particular applicable in the automotive industry.

Traditionally, the welding of two sheets is done by combining a high electrical intensity and periodic pressure, also called “clamping force.”

More specifically, first, the clamping force is increased between said two sheets to be assembled. Next, during a second phase, and once the two sheets are clamped, current is passed between two electrodes that are positioned on either side of said sheets.

The passage of the current between the two electrodes causes an increase in the temperature at the relevant zone of the sheets, up to the melting point between the two sheets, which, after solidification, creates a welding point at the sheet-sheet interface.

In the case of the welding of aluminum, the clamping force reduces the contact resistance between the sheet and the electrode.

The pressure maintains the contact between the electrode and the assembly of sheets. To weld, a clamp presses the assembly with electrodes made from copper, a material that is an excellent conductor of both electricity and heat. This choice makes it possible to reduce the heated zone, which is limited to the contact zone between the two sheets to be welded.

Once the melting point is reached, the pressure is maintained, and the electrical intensity is stopped in order to cool the welding point before separating the electrodes from the assembled sheets, then proceeding to the next welding point.

The welding parameters therefore depend in particular on the electrical resistance of the sheets, the interface resistance between the sheets and the electrode, the total thickness of the assembly and the diameter of the electrodes.

Such a method is for example commonly used in the assembly of thin steel sheets.

This method can also be implemented, albeit less commonly, for aluminum sheets.

Regarding the electrode itself, known from document WO 2016/203122 of the state of the art is a welding electrode for steel sheets, in particular sheets having an anti-corrosion coating, and the base composition of which consists of an alloy of copper, chromium and zirconium, and further comprising phosphorus and/or magnesium.

The proportion of chromium in the alloy is between 0.4 and 0.8% by weight, that of zirconium is between 0.02 and 0.09% and the total proportion of phosphorus and magnesium is greater than 0.005% by weight, with a magnesium content of less than 0.1% by weight and a phosphorus proportion of less than 0.03% by weight. The remainder of the composition consists of copper.

The metallurgical structure of this electrode is particular and comprises incoherent chromium precipitates, more than 90% of which have a projected surface smaller than 1 μm², said incoherent chromium precipitates having dimensions between 10 and 50 nm. Furthermore, said electrode has a fiber structure.

The electrical conductibility of such an electrode for welding steel sheets is greater than 85% IACS.

Such electrodes are particularly interesting for welding steel sheets, in particular because they withstand the corrosion phenomenon better than the typical electrodes. This corrosion phenomenon results from the chemical reaction of the copper from the electrode and the zinc from the coating with the iron from the steel sheet, and leads to a degradation of the surface layer of the electrode, requiring a regular removal of the layer of corrosion, or even changing electrodes.

Whatever the case may be, in the case of welding steel sheets, the temperature at the welding point reaches a value of 1560° C., and, during the contact with the surface of the steel sheet, the surface of the electrode will reach a temperature above 700° C.

Yet at such temperature levels, on the one hand, the chemical reaction that leads to the corrosion of the surface of the electrode is accelerated, but additionally, the very material of the electrode will deform through a wear phenomenon called “hot creep” resulting in a lateral detachment of the surface layer from the electrode and therefore a widening of its ends.

As a result, the contact surface between the electrode and the sheet is made larger, and it is then necessary to increase the current density to maintain a quality of the welding point of the sheets. However, an increased surface and an increased current mean an even broader corrosion.

The electrode as described in international application WO 2016/203122 thus makes it possible to improve the creep resistance at temperatures above 700° C., and which may in some cases reach 800° C., during the welding of steel sheets to one another.

However, the conductibility of such electrodes may be further improved.

Furthermore, it should also be noted that in order to decrease the weight of automobile bodies, with the aim of limiting fuel consumption, more and more vehicle builders today are replacing steel sheets with aluminum sheets, in particular made from aluminum alloys such as Al—Mg—Si (aluminum-magnesium-silicon) alloy or Al—Mg—Mn (aluminum-magnesium-manganese) alloy.

Indeed, the density of aluminum is 35% of the density of the steel sheets used to date.

It should also be noted that the tendency to replace steel sheets with those made from aluminum alloy is further amplified by the development of electric cars and the need to improve the autonomy of the batteries of the latter.

Another advantage of using aluminum sheets is an improved corrosion resistance, making the presence of a zinc-based anticorrosion coating, which was necessary in steel sheets, now unnecessary.

Furthermore, it has proven to be entirely possible for vehicle builders to use steel sheet body assembly lines with resistance welding robots in order to assemble aluminum sheet bodies. This is a real advantage for companies, given that it is not necessary to invest in a dedicated assembly technique (gluing, clinching, riveting, laser, etc.).

At this time, vehicle builders for example use electrodes made from a Copper-Zirconium alloy (0.15%) for the resistive welding of aluminum sheets for vehicle bodies, these electrodes also commonly being implemented to weld steel sheets.

In the case of aluminum sheets, the welding point must reach a contact temperature between the two sheets of 660° C., substantially lower than the temperature of 1560° C. that is reached at the welding point of two steel sheets. The surface temperature of the contact sheet with the electrode will therefore also be lower than that observed during the welding of the steel.

Indeed, the much better electrical conductivity of aluminum compared with that of steel (4 to 5 times higher) greatly reduces the resistive heating, which makes it possible to achieve melting at the welding point.

As a result, under similar welding conditions, it is necessary, in order to weld two aluminum sheets, to significantly increase the applied intensity, typically by 120% compared with the intensity implemented for the welding of steel sheets, by simultaneously reducing the welding time, the latter typically having to be divided by two relative to that of steel.

The energy dissipated in the electrode is proportional to the square of the intensity, the electrical resistance of the electrode, and the welding time. Concretely, this dissipated energy is 2.4 times higher in an electrode used for welding aluminum sheets relative to an electrode for steel.

The electrical resistance being inversely proportional to the electrical conductivity, it is necessary, in order to weld aluminum, to have an electrode having an electrical conductivity greater than 90% IACS (International Annealed Copper Standard), whereas a conductivity greater than 75% IACS is required to weld steel.

Furthermore, in order to have an acceptable lifetime of the welding electrodes of the aluminum sheets, it is also necessary to account for the chemical and thermomechanical reactions that take place during this welding, during the contact of the surface of the electrode with the aluminum sheet.

The chemical reaction is the result of the hot contact between the aluminum of the sheet and the copper of the electrode, which forms a layer of oxygen, aluminum and copper alloy. This layer is substantially more resistive than the layer of copper and zinc alloy that forms on the surface of the electrode during the welding of two steel sheets coated with zinc anti-corrosion protection.

The surface layer of the electrode, during the welding of aluminum sheets, is therefore much more susceptible to heating up, under the effect of the resistance and the applied intensity, than the matrix of this same electrode, until favoring the adhesion, by melting, of oxidized aluminum to the surface of the electrode, which should be avoided.

Typically, the surface temperature of an electrode during the welding of the aluminum is between 500 and 550° C., while this same temperature is above 700° C. during steel welding.

Thus, the temperature deviation between the surface of the electrode and the temperature of the metal to be welded is much higher in the case of the welding of steel, relative to the welding of aluminum sheets.

Indeed, as already mentioned above in the description, the contact temperature between the two sheets when the latter are made from steel must reach 1550-1560° C. in order for melting to occur, while the surface temperature of the electrode is above 700° C., which results in a temperature deviation on the order of 750-850° C.

In the case of the welding of aluminum, the contact temperature between the two sheets must reach 660° C., while the surface of the electrode has a temperature on the order of 500 to 550° C., which results in a maximum temperature deviation on the order of 160° C.

This is particularly true given that, in the case of the welding of steel sheets, the zinc surface layer protects the steel of the sheet, during the hot welding, from corrosion. The layer of zinc blocks the heating of the sheet through the effect of the latent melting heat of the zinc and prevents direct contact of the iron from the steel with the air.

Such a surface layer of zinc does not exist on aluminum sheets. As a result, no protection is provided in the case of welding aluminum sheets. Thus, the layer of alloy comprising oxygen, aluminum and very resistive copper, and which accumulates on the surface of the electrode upon each welding of two aluminum sheets to one another, will increase this resistive effect and increase the contact temperature between the electrode and the aluminum sheet, until reaching the melting temperature of the aluminum.

At that moment, there is an expulsion from the welded point, in other words, an ejection of molten metal at the outer face of the sheets, and the quality of the welded point is degraded as a result.

Regarding the thermodynamic reaction during the contact of the surface of the electrode with an aluminum or steel sheet, the latter results, on the one hand, from the hot creep of the surface of the electrode during the welding, under the effect of the clamping force exerted by the welding clamp, and on the other hand, from the surface pulling out of the electrode under the effect of the opening force of the clamp at the end of the welding.

Under the clamping force, the contact surface of the electrode will spread, causing, at an equal welding intensity, a decrease in the current density and a less and less localized heating. The diameter of the welded point is reduced as a result, and becomes insufficient to guarantee the assembly of the two sheets.

In the case of the welding of steel, under the opening force, the more the electrode is adhered to the sheet, the more micro-pulling out occurs and degrades the contact surface of the electrode.

To return to the welding of aluminum, it is imperative to avoid the expulsion of the welded point when a surface temperature of the electrode is reached close to the melting temperature of the aluminum.

To that end, it may prove interesting to increase the clamping force. Indeed, the higher the clamping force is, the better the contact is between the sheet and the electrode, the lower the contact resistance is and the less heating there is at the contact surface of the electrode, and, the lower the temperature is, the less oxidation of the aluminum and transfer of aluminum oxide to the surface of the electrode there is.

However, with the spreading of the contact surface, resulting from the clamping force in particular, it is necessary to increase the welding current in order to maintain a satisfactory welded point quality, which results in an even greater degradation of the electrode.

When the degradation of the surface of the electrode is too great, mechanical stripping of this surface is then essential, in order to guarantee the quality of the welded point.

Such a stripping operation has the drawback, however, of requiring stopping the resistance welding robot on the assembly line of the sheets, inevitably causing a decrease in productivity, in particular if the stripping frequency is too high.

It therefore appears necessary to propose an electrode in particular meeting the needs of the method for resistance welding aluminum sheets, having an optimal electrical conductibility and an improved welding performance compared with the Cu—Zr electrodes at 0.15% zirconium typically used for this method.

### BRIEF SUMMARY OF THE INVENTION

More generally, proposed is an electrode in all cases having an improved electrical conductibility, in particular for welding aluminum-based sheets, but also for welding steel sheets, and which makes it possible to reduce the contact resistance between the sheet and the electrode, thus avoiding heating on the contact surface of the electrode and the resulting drawbacks.

To that end, the present invention relates to an electrode made from an alloy of copper, chromium, zirconium and phosphorus for welding metal sheets made from steel and aluminum or aluminum alloys, characterized in that the alloy is made up of chromium in a proportion greater than or equal to 0.1% and less than 0.4% by weight, zirconium in a proportion between 0.02 and 0.04% by weight, phosphorus in a proportion of less than 0.015% by weight, the rest of the composition being copper and unavoidable impurities in a proportion of less than 0.1% by weight, and the electrical conductibility of said electrode being greater than or equal to 90% IACS (International Annealed Copper Standard).

Advantageously, the structure of the electrode comprises incoherent chromium precipitates, more than 90% of which have a projected surface smaller than 1 μm², said incoherent chromium precipitates having dimensions at least between 10 and 50 nm, said electrode further having a fiber structure, visible along a cross-section of the active face of said electrode after surfacing and chemical etching, said structure being made up, on the one hand, of a plurality of radial fibers, said fibers having a thickness of less than 1 mm, and on the other hand, of a substantially central zone without fiber structure having a diameter of less than 5 mm.

Especially preferably, said electrode, when it is implemented in the case of welding aluminum or aluminum alloy sheets, is able to allow the maintenance of a specific pressure greater than or equal to 120 MPa during the welding of two aluminum sheets to one another, in order to limit the contact resistance between said electrode and the outer surface of one of the two aluminum sheets.

The decreased chromium content in the initial alloy, compared with the Cu—Cr—Zr alloy further comprising phosphorus and/or magnesium used to produce welding electrodes for steel sheets in the application WO 2016/203122, allows a substantial improvement in the conductivity, the latter then being systematically greater than or equal to 90% IACS, as will be demonstrated in the examples provided below.

Furthermore, such a reduced chromium content makes it possible, against all expectations, to keep the incoherent chromium precipitates that were already the source of the improved welding performance of the electrode for steel sheets described in international application WO 2016/203122, in particular by increasing the resistance of this electrode to hot creep.

Thus, the electrode according to the present invention is particularly interesting and in particular suitable for use in welding aluminum or aluminum alloy sheets, but also for welding steel sheets, in particular due to the especially high electrical conductibility that it exhibits.

Advantageously, the proportion of chromium is between 0.2 and 0.3% by weight.

According to another particularity of the invention, the proportion of zirconium is between 0.03 and 0.04% by weight.

Interestingly, the proportion of phosphorus is less than 0.01% by weight.

Preferably, the proportion of unavoidable impurities is less than 0.05% by weight.

Quite particularly, a weight coefficient is assigned to each chemical element that may be present as impurity in the alloy, as a function of the effect of said chemical element on the electrical conductibility, the sum of the weighted proportions of each of said chemical elements, in parts per million, being less than 5000.

Still more preferably, the sum of the weighted proportions of each of said chemical elements, in parts per million, is less than 2000.

The present invention further relates to a method for manufacturing a welding electrode according to the invention, by continuous pouring, from an alloy made up of chromium in a proportion greater than or equal to 0.1% and less than 0.4% by weight, zirconium in a proportion between 0.02 and 0.04% by weight, phosphorus in a proportion of less than 0.015% by weight, the rest of the composition being copper and unavoidable impurities in a proportion of less than 0.1% by weight, said method comprising at least the following steps:

a) melting the various components of the alloy, namely the copper, the chromium, the zirconium and the phosphorus and/or magnesium at a temperature greater than or equal to 1200° C.;

b) continuously pouring through a cylindrical die head having a diameter d making it possible to obtain a bar with a diameter close to the diameter d of the die head while keeping the liquid metal in the pouring furnace at a temperature between 1100 and 1300° C.;

c) solidifying said bar and cooling to a temperature below 100° C., the cooling speed being at least equal to 10° C./s until reaching a bar temperature of 1060° C., then at least equal to 15° C./s between 1060 and 1040° C., then at least equal to 20° C./s between 1040 and 1030° C., then at least equal to 25° C./s between 1030 and 1000° C., then at least equal to 30° C. between 1000 and 900° C., then at least equal to 20° C./s for temperatures below 900° C., until the bar has cooled to a temperature of no more than 100° C.;

d) cold working in order to obtain a rod with a diameter of less than 20 mm;

e) shearing said rod in order to obtain billets, then punching or machining by removing material in order to give said electrode its final shape,

said method comprising at least one step for aging or annealing treatment before and/or after step e) for shaping the electrode, and in which method the metallurgical structure of the active face of said electrode comprises incoherent chromium precipitates, more than 90% of which have a projected surface smaller than 1 μm², said incoherent chromium precipitates having dimensions at least between 10 and 50 nm, said electrode further having a fiber structure, visible along a cross-section of the active face of said electrode after surfacing and chemical etching, said structure being made up, on the one hand, of a plurality of radial fibers, said fibers having a thickness of less than 1 mm, and on the other hand, of a substantially central zone without fiber structure having a diameter of less than 3 mm, and the electrical conductibility of said electrode being greater than or equal to 90% IACS (International Annealed Copper Standard).

Preferably, the melting of the different components of the alloy of step a) is done at a temperature between 1200° C. and 1300° C.

The continuous pouring of step b) is advantageously done while maintaining a temperature of the liquid metal in the pouring furnace between 1150 and 1250° C.

The cooling of said bar in step c) can be done at a cooling speed at least equal to 30° C./s for temperatures below 900° C., until the bar is cooled to a temperature of no more than 100° C.

The aging treatment can, in a first embodiment of the method, be done before step e) for shaping of the electrode and consist of a precipitation treatment done at a temperature between 450 and 480° C. for a period of 1 to 2 h.

In a second embodiment, the precipitation treatment, carried out at a temperature between 450 and 480° C., is done for a period of 1 to 2 h, according to step e) for shaping the electrode.

The diameter d of the die head is preferably between 20 and 70 mm, preferably between 20 and 40 mm.

During step d) for cold deformation, an outside machining operation, less than 0.5 mm thick, is advantageously carried out to eliminate the surface defects generated during the solidification step c).

The present invention has many advantages.

First of all, due to the composition of the base alloy used to produce the electrode according to the invention, the electrical conductibility of the latter is particularly high, typically greater than or equal to 90% IACS. This improved conductibility makes it possible to address the decreased electrical resistance of the aluminum, relative to that of steel.

Secondly, the electrode according to the invention has a substantially improved resistance to creep, compared to the Cu—Zr electrodes currently used to weld aluminum sheets in the automotive industry. This improved creep resistance results from a high hardness that is preserved despite the heat generated in the electrode and on its surface during welding.

As a result, the contact surface of the electrode with the sheet will be less subject to spreading under the effect of the clamping force exerted by the welding clamp and therefore the adhesion of the electrode on the sheet will be limited. As a result, during the opening of the clamp, less surface micro-pulling out will occur at the electrode.

This creep resistance makes it possible to reduce the spreading effect of the contact surface, which is typically able to cause a decrease in the current density and a reduction in the diameter of the welded point, which would become insufficient to guarantee the assembly of the two sheets.

Third, this creep resistance makes it possible to maintain a high specific pressure and to reduce the contact resistance. In the case of the welding of aluminum or aluminum alloy sheets, a poor contact resistance favors the diffusion of aluminum in the copper on the surface of the electrode and the transfer of aluminum oxide onto the surface of the electrode. The contact resistance results from the formation of a layer of highly resistive oxygen, aluminum and copper alloy that accumulates on the surface of the electrode upon each welding.

In the case of steel welding, the specific pressure is on the order of 80 MPa; in the case of aluminum, this pressure must remain greater than 120 MPa to avoid an excessive contact resistance.

The inventive electrode makes it possible to maintain a specific pressure greater than 120 MPa during the welding of aluminum sheets without generating a rapid spreading of the surface of the electrode through a significant hot creep.

Lastly, it emerges from the preceding that, relative to the current Cu—Zr electrodes, the inventive electrode may be used during a higher number of cycles before the mechanical stripping operation is necessary to restore the quality of the surface of said electrode, resulting in a non-negligible gain in terms of productivity.

### BRIEF DESCRIPTION OF THE SEVERAL VIEWS OF THE DRAWINGS

Other features and advantages of the invention will emerge from the following detailed description of non-limiting embodiments of the invention, in reference to the sole appended FIGURE.

The FIGURE is a schematic view, showing on the left, an electrode according to the invention and, on the right, an electrode made from copper and zirconium alloy, containing 0.15% by weight of zirconium, and currently used by automobile builders for welding aluminum sheets.

The gray part visible at the rounded end of each of the two electrodes shows the quantity of material to be eliminated, by mechanical stripping, to maintain an optimal quality of the welded point, after having performed welding by applying identical parameters to the two electrodes, in particular in terms of number of weld points, applied electrical intensity, welding time, etc.

### DETAILED DESCRIPTION OF THE INVENTION

The present invention in particular relates to an electrode manufactured from an alloy made up of:
chromium in a proportion greater than or equal to 0.1% and less than 0.4% by weight, advantageously between 0.2 and 0.3% by weight,
zirconium in a proportion between 0.02 and 0.04% by weight, more preferably between 0.03 and 0.04% (or between 300 and 400 ppm, 1 ppm corresponding to 1 mg/kg),
phosphorus in a proportion of less than 0.015% by weight, advantageously less than 0.01% (less than 100 ppm),
the rest of the composition being copper and unavoidable impurities in a proportion of less than 0.1% by weight, knowing that, still more preferably, the proportion in impurities is less than 0.05%, or less than 500 ppm.

The presence of impurities in an alloy is inherent to the process of developing that alloy. The total proportion of all of the impurities in the alloy used to produce the electrode of the invention must not, however, exceed 0.1% by weight so as not to have a negative impact on the characteristics of said electrode, in particular on its particularly high electrical conductibility, greater than or equal to 90% IACS (International Annealed Copper Standard).

The unavoidable impurities result from the development of the alloy and group together all of the elements other than those included in the composition of the alloy, which may harm the conductibility, but excluding silver.

Indeed, an addition up to 0.05% by weight (500 ppm) of silver is conceivable without detriment to the performance of the electrode.

Silver will therefore not be taken into account in the impurities and may be added up to a proportion of 500 ppm without harming the characteristics of the electrode according to the invention.

As mentioned above, it is important for the impurities that are present not to reduce the electrical conductibility. Yet certain elements considered here to be impurities have more of an impact on reducing the electrical conductibility than others.

This should therefore be taken into account in assigning each impurity a weight coefficient, as indicated in table 1 below:

TABLE 1
Value of the weight coefficient according to
the chemical element
Value of the weight coefficient according to
the chemical element

| 1 | 2 | 5 | 10 | 20 |
|---|---|---|---|---|
| Ni | Al | As | B | S |
| Pb | Ge | Be | Fe | Ti |
| Zn | Sn | Co | Se | |
| | | Mg | Si | |
| | | Mn | | |
| | | Sb | | |

The sum of the proportion of each impurity in weighted ppm of the coefficient must not exceed the value of 5000.

Advantageously, the weighted sum of the impurities does not exceed 2000.

Thus for example, if in the alloy, as impurities, there are, in the indicated proportions, 100 ppm of silicon (Si), 100 ppm of iron (Fe), 50 ppm of tin (Sn), 50 ppm of aluminum (Al), 50 ppm of zinc (Zn), 20 ppm of sulfur (S) and 100 ppm of other impurities, the total proportion of impurities is 470 ppm.

The weighted sum of the impurities is calculated as follows, by multiplying the proportions, in ppm, of each impurity present by their respective weight coefficient, and adding the weighted proportions.

Again using the impurities given in the example above, their weighted sum is therefore calculated as follows:

100×10+50×2+50×2+50×1+20×20=2650.

The present invention also relates to a method for manufacturing a resistance welding electrode from an alloy whose composition consists of copper, chromium, zirconium and phosphorous, in the proportions in particular indicated above.

The method for manufacturing the electrode is a continuous pouring method and it comprises at least the following steps:

a) melting the different components of the alloy at a temperature above 1200° C., preferably between 1200° and 1300° C.;

b) performing continuous pouring through a cylindrical die head, or a cylindrical mold, having a diameter d making it possible to obtain a bar;

This pouring can be done at a temperature for keeping the liquid metal in the pouring furnace between 1100 and 1300° C., preferably between 1150 and 1250° C.

c) solidifying said bar and cooling it, preferably at a defined cooling speed to a temperature below 100° C., the cooling speed being at least equal to 10° C./s until reaching a bar temperature of 1060° C., then at least equal to 15° C./s between 1060 and 1040° C., then at least equal to 20° C./s between 1040 and 1030° C., then at least equal to 25° C./s between 1030 and 1000° C., then at least equal to 30° C. between 1000 and 900° C., then at least equal to 20° C./s for temperatures below 900° C., until the bar has cooled to a temperature of no more than 100° C.

The cooling speed is therefore at least 20° C./s until reaching at least a bar temperature of 100° C.

Preferably, the cooling speed is at least equal to 30° C./s for temperatures below 900° C., until the bar is cooled to a temperature of no more than 100° C.

Advantageously, the cooling of said bar in step c) is done at a cooling speed still at least equal to 30° C./s for temperatures below 700° C.

This solidification and cooling step does not include a specific heat treatment, the placement in solution being able to be done as of the end of solidification at 1060° C.

d) a cold deformation of said bar is done in order to obtain a rod with a diameter smaller than 20 mm, preferably between 12 and 19 mm; optionally, an outer machining operation, advantageously less than 0.5 mm thick, can be done so as to eliminate any surface defects generated by the preceding step;

e) shaping of the electrode is done by shearing said rod in order to obtain billets, then punching or machining by removing material in order to give said electrode its final shape.

During the method, at least one aging treatment, or annealing treatment, is done. This step takes place before and/or after the step e) for shaping of the electrode.

This aging treatment consists of a heat treatment that can be done in different ways.

Preferably, it is a precipitation treatment carried out at a temperature between 450 and 480° C., for a period of 1 h to 2 h.

It is therefore possible to perform this precipitation treatment at a temperature between 450 and 480° C., for a period of 1 h to 2 h between step d) for cold deformation and step e) for shaping of the electrode.

According to another embodiment, the precipitation treatment is carried out after step e) for shaping of the electrode, as sole aging treatment of the method.

The implementation of a precipitation treatment at the very end of the method, after step e), has the advantage of providing greater stability to the mechanical characteristics of the electrode.

Two precipitation treatments under the aforementioned duration and temperature conditions can also be carried out, the first before step e), the second after this step e) for shaping of the electrode.

Particularly advantageously, in step b) of the inventive method, the diameter d of the cylindrical continuous pouring die head is smaller than 70 mm.

Preferably, said diameter d is between 20 and 70 mm, and still more preferably, this diameter is between 20 and 40 mm.

Furthermore, the cooling speed applied during step c) of the method and allowing the solidification of the bar, then the solid cooling, is especially important, causing a rapid solidification and an extremely powerful peripheral cooling.

Preferably, the cooling speed is also variable as a function of the temperature of said bar.

More specifically, said cooling speed is advantageously at least equal to 10° C./s when the bar has a temperature greater than 1060° C., then at least equal to 15° C./s when the temperature is between 1060 and 1040° C., then at least equal to 20° C./s when the temperature is between 1040 and 1030° C., then at least equal to 25° C./s when the temperature is between 1030 and 1000° C., then at least equal to 30° C./s between 900 and 1000° C. For bar temperatures below 900° C., the cooling is preferably done at a speed at least equal to 20° C./s.

The cooling speed can further be at least equal to 30° C./s for temperatures below 900° C.

Preferably, in the method according to the invention, the cooling is not applied on a solid, but on a liquid and begins as of solidus, that is to say, at a temperature on the order of 1070° C. In particular, a temperature range has been shown, between 1060 and 900° C., to improve the placement in solution with a minimum cooling speed that was used above when defining the method.

Below 900° C., placement in solution is impossible; for temperatures below 900° C., one will be sure to continue the cooling with a minimum of 20° C./s so as not to generate uncontrolled aging.

More specifically, very rapid solidification and cooling, up to a temperature where the diffusion of the chromium atoms is limited, allows a homogeneous distribution of the coherent and incoherent chromium precipitates.

These cooling conditions, which are further applied on a cylindrical mold having a reduced diameter between 20 and 70 mm, preferably between 20 and 40 mm, participate in obtaining a bar with a columnar solidification texture oriented radially. This texture is visible by making a transverse cut in said bar, and over the entire volume of the latter.

The die head or the mold, having a cylindrical shape, is preferably surrounded by an enclosure within which either an oil or a coolant gas or water circulates, so as to allow solidification and cooling.

Another advantage of the inventive method lies in the fact that it makes it possible to avoid a dynamic hot recrystallization, due to heating and simultaneous deformation. As a result, the precipitates and textures of interest resulting from the implementation of the inventive method are retained.

Within the basic alloy used to produce the innovative welding electrodes, there is preferably a chromium content within a proportion greater than or equal to 0.1% and less than 0.4% by weight, this proportion preferably being between 0.2 and 0.3%.

Using the method according to the invention, the incoherent chromium precipitates, that is to say, particles having no crystallographic relation with the matrix, exceed the solubility limit.

Indeed, in the inventive method, the application of the quenching treatment as of solidification of the alloy, which is complete at a temperature on the order of 1070° C., makes it possible to maximize the solubility of the chromium in the copper and to maintain the copper chromium eutectic at the grain joints.

It may be determined that, particularly surprisingly, a proportion of chromium greater than or equal to 0.1% and less than 0.4% makes it possible to produce the desired chromium precipitation.

Thus, contrary to the idea commonly held in the state of the art, despite a decrease in the proportion of chromium within the alloy, the combination of steps of the method implemented on the composition of the alloy described here makes it possible to keep the incoherent chromium precipitates, without creating overly large chromium precipitates, which could cause delaminations during step d) for cold transformation.

The very fine columnar solidification texture, obtained by the implementation of the inventive method, makes it possible particularly advantageously to distribute the heterogeneity of the chromium composition (chromium in solid solution, eutectic chromium and metal chromium) homogeneously, in the entire volume of the welding electrode obtained by said method.

These chromium precipitates are the source of the improved welding performance of the electrode, by increasing the resistance of the latter to hot creep. As a remark, for the welding of steel sheets with a zinc coating, these precipitates serve to delay or block the diffusion of iron and zinc, which are the source of the chemical corrosion of the active face of said electrode.

The inventive method, and in particular the preferred application of the cooling as of solidus, also promotes a homogeneous distribution of the coherent chromium precipitates, that is to say, the precipitates having a continuity with the crystallographic structure of the matrix.

Through the implementation of the inventive method, the obtained electrode also has a fiber structure, due to the presence of copper precipitates, or grains, which in turn have a very fibered form.

According to a longitudinal section of an electrode according to the invention after punching (results not shown), it appears that the fiber structure is right-left symmetrical, the fibers starting from the active face, and near the inner cooling face of the electrode and becoming tighter toward the skirt of the electrode.

In a cross-section of this same electrode, the fibers are comparable to the spokes of a wheel whereof the hub, corresponding to the central zone of the electrode without distinctive fiber structure, has a diameter smaller than 5 mm, preferably smaller than 3 mm. The fine radial fibers in turn have a thickness advantageously smaller than 1 mm, and still more advantageously smaller than 0.5 mm.

This fibered texture, which is highly characteristic of the electrode obtained by implementing the inventive method, is the direct result of the metallurgical structure obtained after step c) of the method, and is very different from the fine and homogeneous structure of certain conventional electrodes.

The fiber structure of the electrode obtained by the present method, in particular due to the presence of copper grains in needle form having a significant length, makes it possible to improve the resistance to thermomechanical stress fields, comprising the deformation field and the temperature field, of the active face of said electrode during welding.

More specifically, the fiber structure of the inventive electrode favors, during the welding of steel or aluminum sheets, a discharge of calories radially and longitudinally, from the central zone of the electrode, where the temperature is maximal, toward the cold zones, that is to say, the inner face and the periphery of the electrode. As a result, the inventive electrode is in particular more resistant to the creep phenomenon.

Mention has already previously been made of the composition of the base alloy in order to obtain said electrode according to the invention. This alloy comprises copper and chromium, the latter component being present in the alloy in a proportion greater than or equal to 0.1% and less than 0.4%.

Aside from these two components, the alloy according to the invention also comprises zirconium in a proportion preferably between 0.02 and 0.04% by weight. Such a proportion advantageously makes it possible to avoid generating precipitates that could encourage cold cracking of the material.

The proportion of zirconium is, still more advantageously, between 300 and 400 ppm, or between 0.03 and 0.04%.

It is also advantageous for the base alloy to comprise phosphorus in a proportion of less than 0.015% by weight, this proportion preferably being less than 100 ppm.

This element, which is both more deoxidizing than chromium and less so than zirconium, facilitates good control of the residual zirconium content when large production quantities are considered.

The present invention also relates to an electrode that may be obtained using the method previously described.

As already previously mentioned, said electrodes according to the invention have original microscopic properties relative to the conventional electrodes.

Analyses by transmission microscopy of the structure of the material of the inventive electrodes, before and after welding, have made it possible to show differences relative to the microscopic structure of the conventional Cu—Zr electrodes, and in particular the morphology of the crystalline grains as well as the dimensions and distribution of the chromium precipitates.

In particular, it is observed on the microscopic scale that the material of the electrode according to the invention comprises more than 90% incoherent chromium precipitates, which have a projected surface of less than 1 μm².

Furthermore, on the nanometric scale, in addition to coherent chromium precipitates having dimensions on the order of 2 to 5 nm, a population of incoherent chromium precipitates is observed with dimensions between 10 and 50 nm, and more specifically between 10 and 20 nm.

These incoherent chromium precipitates are characteristic of the inventive electrodes and are not visible at the material of the conventional Cu—Zr electrodes.

Furthermore, it should be noted that the performed analyses have also demonstrated a dimensional evolution of these incoherent chromium precipitates, during the sheet welding step, in the case at hand steel sheets with zinc coating, using the inventive electrode.

Indeed, during the welding of steel sheets coated with zinc, a coalescence is observed of the precipitates on approaching the active face of the electrode, and more specifically, incoherent nanometric precipitates from 30 to 50 nm in the layer β and from 100 to 150 nm in the layer γ.

Typically, the layer β of the chemical reaction layer is furthest from the surface of the electrode. It is a yellow diffusion layer of the zinc in the copper, at 40% zinc. On the surface, the chemical reaction layer comprises an iron-rich layer, typically 25%, that forms during the adhesion of the steel sheet on the surface of the electrode at a temperature above 850° C. Lastly, between the layer β and the iron-rich layer, there is the layer γ at 55% zinc.

Other analyses conducted on the electrodes according to the invention have shown that the incoherent chromium precipitates present in the layer γ are enriched with iron, and as a result, make it possible to block the diffusion of the iron.

Lastly, hot mechanical characterization tests were also conducted on electrodes obtained using the method according to the invention. The results of these tests showed that the creep temperature increased by 100° C. with the present electrodes, relative to the creep temperature of certain conventional electrodes.

More specifically in the case of welding steel sheets, generally, the creep of the active face of the conventional electrode becomes sensitive, during the welding operation, at a temperature on the order of 700° C. Indeed, with the surface softening of the electrode, there is creep of the surface and cracking of the layer γ, which encourages a diffusion of the iron in the layer γ, then in the layer β in the form of Fe—Zn precipitates. The layer β becomes resistive, and heats beyond 850° C., causing the layer γ to disappear. As a result, the material of said conventional electrode will begin to pull out over the course of the welding points, causing a rapid degradation of the welding point.

On the contrary, for an electrode according to the invention, in the case of welding steel sheets, this creep temperature is on the order of 800° C., which makes it possible to delay the mechanical stress of the layer γ, thus encouraging the protective maintenance of said layer γ, at the active face of said electrode.

As a result, the electrodes obtained by implementing the present method in particular have an increased lifetime and improved welding performance.

In order to illustrate the interest and technical characteristics of the electrode according to the invention for the resistive welding of aluminum sheets, three examples comparing the performance of said electrode to the copper-zirconium (0.15%) electrodes currently used by builders of automobiles with aluminum body, are given below.

### Example 1: Comparative Tests of Characteristics of the Layer 3 mm from the Surface of the Electrode Before and After Heat Treatment

The Brinell hardness (hardness HB) was measured at the surface and at least 3 mm from the surface of a Cu—Zr electrode currently used by automobile builders and of an electrode according to the invention, before and after heat treatment of 500° C. applied for a duration of 8 h.

Furthermore, the % IACS conductivity was also measured for these two electrodes, before and after heat treatment (HT).

The composition of the alloy that has been used to manufacture the tested electrode is as follows:

Cr: 0.2 to 0.3%;

Zr: 300 to 400 ppm;

P: 80 to 120 ppm;

Remainder: copper and unavoidable impurities in a proportion of less than 300 ppm with a weighted sum <2000.

The results obtained during these comparative tests are summarized in table 2 below.

TABLE 2
Comparison of the “hardness” and “conductivity”
characteristics between a typical Cu—Zr electrode and
an electrode according to the invention before and
after heat treatment

| | Cu—Zr | | Invention | |
|---|---|---|---|---|
| | before HT | after HT | before HT | after HT |
| hardness HB | 170 | 100 | 155 | 140 |
| surface | | | | |
| hardness HB | 140 | 120 | 150 | 140 |
| surface - 3 mm | | | | |
| conductivity | 86 | 94 | 91 | 93 |
| %IACS - 3 mm | | | | |

The results presented in table 2 show that, compared with the conventional Cu—Zr electrode, the “hardness HB” and “conductivity % IACS” of the electrode according to the invention are more constant between before and after the heat treatment that has been applied.

Indeed, the surface of a new Cu—Zr electrode, before heat treatment, is less conductive than the surface of a new electrode according to the invention, with a conductivity % IACS of 86 versus 91.

As a result, the conventional Cu—Zr electrode heats up more significantly and does not withstand thermal softening as well, which is reflected by a decrease in hardness after heat treatment at 100 HB versus 140 HB for the electrode according to the invention.

Such a difference in conductivity ultimately leads to a greater surface creep for the Cu—Zr electrode than for the electrode according to the present invention.

### Example 2: Comparative Tests of Characteristics of the Surface Layer after Welding

The Brinell hardness (hardness HB) was measured at the surface and at least 3 mm from the surface of a Cu—Zr electrode currently used by automobile builders and of an electrode according to the invention, before welding (“new” electrode) and after welding (“end of welding”). For the electrode according to the invention only, the hardness HB was also measured after 30 welding points.

Furthermore, the % IACS conductivity was also measured for these two electrodes, before and after welding, and after 30 welding points for the electrode according to the invention.

The results obtained during these comparative tests are summarized in table 3 below.

TABLE 3
Comparison of the “hardness” and “conductivity”
characteristics between a typical Cu—Zr electrode and
an electrode according to the invention before and
after welding

| | Cu—Zr | | Invention | | |
|---|---|---|---|---|---|
| | | end of | | welding 30 | end of |
| | new | welding | new | pts | welding |
| hardness HB | 170 | 125 | 155 | 155 | 150 |
| surface | | | | | |
| hardness HB | 140 | 150 | 150 | 150 | 150 |
| surface - 3 mm | | | | | |
| Conductivity | 88 | 86 | 90 | 90 | 92 |
| %IACS - 3 mm | | | | | |

The results summarized in this table also demonstrate that the electrode according to the invention is much more consistent between before and after welding.

The electrode according to the invention works, throughout its entire operating cycle, on the one hand with a higher conductivity (between 90 and 92 versus 86-88) and on the other hand with a better resistance to softening. Indeed, the electrode according to the invention further has a surface hardness HB of 150 at the end of welding, whereas the usual electrode has, at the end of welding, a hardness of 125 HB.

The obtained results also show that the loss of softening on the Cu—Zr electrodes is localized on the surface. Indeed, the hardness at least 3 mm from the surface remains substantially constant, on the order of 140-150 HB, and the conductivity has not risen to 94. Despite this, the surface creep of the Cu—Zr electrode leads to the spreading of the contact face and to an insufficient welded point diameter.

The electrode according to the invention works in a range where it retains its mechanical characteristics.

In particular, the electrode according to the invention retains a high level of hardness, despite the heating generated in the electrode during the welding, and the creep resistance is thus increased.

As a result, said electrode deforms less during welding, allowing the user to gain productivity because the frequency of mechanical stripping decreases.

### Example 3: Comparative Tests of Welding Performance

The third test, in reference to the sole appended FIGURE, consists of comparing the welding performance between a Cu—Zr electrode typically implemented by builders and an electrode according to the invention.

Due to the better creep resistance during welding, and all other parameters being equal (in terms of welding parameters: intensity, clamping time, cooling in particular), during the mechanical stripping to return the surface of the electrode to the initial state, 15% less material is removed with the electrode according to the invention.

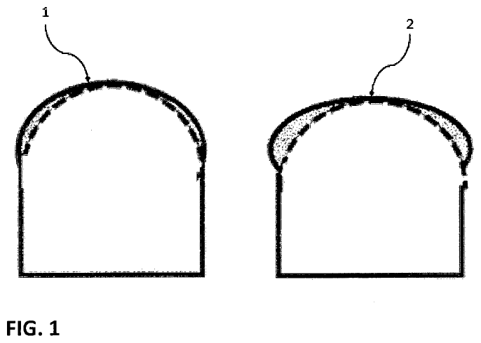

The quantity of material that is removed, during the mechanical stripping operation, from the electrode according to the invention 1 corresponds to the gray part of the attached FIG. 1. This quantity of material needing to be removed is smaller for the electrode of the invention 1, compared with the conventional Cu—Zr electrode 2, the latter experiencing significant creep resulting in spreading of its end, as illustrated in FIG. 1.

A cycle corresponds to the number of points welded before performing the mechanical stripping operation.

It is possible, with the electrode according to the invention, and without changing the welding parameters, on the one hand to increase the number of cycles by 15%, and on the other hand to increase the number of points per cycle by 10%, relative to the average number of cycles and the average number of cycles that can be performed with a Cu—Zr electrode currently used, before it is necessary to perform the mechanical stripping of said electrode of the invention to preserve an optimal quality of the welded point.

The electrode according to the invention therefore makes it possible to improve the productivity by about 27%, without changing the welding parameters.

The electrode according to the invention has very great stability during welding cycles on an aluminum sheet, by implementing the welding parameters specifically defined for an optimal use of the Cu—Zr electrodes.

This means that the welding parameters, defined for these CuZr electrodes, do not degrade the surface of the electrode according to the invention, despite a number of welded points increased by 27% with the latter.

It therefore appears obvious for one skilled in the art that defining the welding parameters specific to the inventive electrode will allow an additional improvement in terms of the number of welded points.

1. An electrode for welding metal sheets made from steel and aluminum or aluminum alloys, comprising:
an alloy being comprised of:
chromium in a proportion greater than or equal to 0.1% and less than 0.4% by weight,
zirconium in a proportion between 0.02 and 0.04% by weight,
phosphorus in a proportion of less than 0.015% by weight,
copper and
unavoidable impurities in a proportion of less than 0.1% by weight,
wherein electrical conductibility of said electrode being greater than or equal to 90% IACS (International Annealed Copper Standard) and
wherein structure of said electrode comprises incoherent chromium precipitates, more than 90% of which have a projected surface smaller than 1 μm², said incoherent chromium precipitates having dimensions at least between 10 and 50 nm,
wherein said electrode further having a fiber structure, visible along a cross-section of the active face of said electrode after surfacing and chemical etching, said structure being comprised of a plurality of radial fibers, said fibers having a thickness of less than 1 mm, and a central zone without fiber structure having a diameter of less than 5 mm.

2. The electrode according to claim 1, wherein said electrode is able to maintain a specific pressure greater than or equal to 120 MPa during the welding of two aluminum sheets to one another, in order to limit the contact resistance between said electrode and the outer surface of one of the two sheets.

3. The electrode according to claim 1, wherein a proportion of chromium is between 0.2 and 0.3% by weight.

4. The electrode according to claim 1, wherein a proportion of zirconium is between 0.03 and 0.04% by weight.

5. The electrode according to claim 1, wherein a proportion of phosphorus is less than 0.01% by weight.

6. The electrode according to claim 1, wherein a proportion of unavoidable impurities is less than 0.05% by weight.

7. The electrode according to claim 1, wherein a weight coefficient is assigned to each chemical element that may be present as impurity in the alloy, as a function of the effect of said chemical element on the electrical conductibility, the sum of the weighted proportions of each of said chemical elements, in parts per million, being less than 5000.

8. The electrode according to claim 1, wherein a sum of the weighted proportions of each of said chemical elements, in parts per million, is less than 2000.

9. A method for manufacturing a welding electrode, the method comprising the following steps:
a) melting the various components of the alloy of claim 1, namely the copper, the chromium, the zirconium and the phosphorus at a temperature greater than or equal to 1200° C.;
b) continuously pouring through a cylindrical die head having a diameter d making it possible to obtain a bar with a diameter close to the diameter d of the die head while keeping the liquid metal in the pouring furnace at a temperature between 1100 and 1300° C.;
c) solidifying said bar and cooling to a temperature below 100° C., the cooling speed being at least equal to 10° C./s until reaching a bar temperature of 1060° C., then at least equal to 15° C./s between 1060 and 1040° C., then at least equal to 20° C./s between 1040 and 1030° C., then at least equal to 25° C./s between 1030 and 1000° C., then at least equal to 30° C. between 1000 and 900° C., then at least equal to 20° C./s for temperatures below 900° C., until the bar has cooled to a temperature of no more than 100° C.;
d) cold working in order to obtain a rod with a diameter of less than 20 mm;
e) shearing said rod in order to obtain billets, then punching or machining by removing material in order to give said electrode its final shape,
said method comprising at least one step for aging or annealing treatment before and/or after step e) for shaping the electrode, and in which method the metallurgical structure of the active face of said electrode comprises incoherent chromium precipitates, more than 90% of which have a projected surface smaller than 1 μm², said incoherent chromium precipitates having dimensions at least between 10 and 50 nm, said electrode further having a fiber structure, visible along a cross-section of the active face of said electrode after surfacing and chemical etching, said structure being made up, on the one hand, of a plurality of radial fibers, said fibers having a thickness of less than 1 mm, and on the other hand, of a substantially central zone without fiber structure having a diameter of less than 3 mm, and the electrical conductibility of said electrode being greater than or equal to 90% IACS (International Annealed Copper Standard).

10. The method for manufacturing the welding electrode according to claim 9, wherein the melting of the different components of the alloy of step a) is done at a temperature between 1200° C. and 1300° C.

11. The method for manufacturing the welding electrode according to claim 9, wherein the continuous pouring of step b) is done while maintaining a temperature of the liquid metal in the pouring furnace between 1150 and 1250° C.

12. The method for manufacturing the welding electrode according to claim 9, wherein the cooling of said bar in step c) is done at a cooling speed at least equal to 30° C./s for temperatures below 900° C., until the bar is cooled to a temperature of no more than 100° C.

13. The method for manufacturing the welding electrode according to claim 9, wherein the aging treatment is done before step e) for shaping of the electrode and consists of a precipitation treatment done at a temperature between 450 and 480° C. for a period of 1 to 2 h.

14. The method for manufacturing the welding electrode according to claim 9, wherein according to step e) for shaping the electrode, a precipitation treatment is carried out at a temperature between 450 and 480° C. for a period of 1 to 2 h.

15. The method for manufacturing the welding electrode according to claim 9, wherein the diameter d of the die head is between 20 and 70 mm, preferably between 20 and 40 mm.

16. The method for manufacturing the welding electrode according to claim 9, wherein, during step d) for cold deformation, an outside machining operation, less than 0.5 mm thick, is carried out to eliminate the surface defects generated during the solidification step c).
